(19) United States
(12) Patent Application Publication
(10) Pub. No.: US 2015/0269874 A1
(43) Pub. Date: Sep. 24, 2015

(54) ELECTRONIC SIGN BOARD, PORTABLE SIGN SHACK AND THRESHOLD TRANSPORT DOLLY

(71) Applicant: Kenneth L. MACDOUGALL, Dartmouth (CA)

(72) Inventor: Kenneth L. MACDOUGALL, Dartmouth (CA)

(21) Appl. No.: 14/667,369

(22) Filed: Mar. 24, 2015

(30) Foreign Application Priority Data
Mar. 24, 2014 (CA) 2 847 136

(51) Int. Cl. G09F 7/18; B62B 1/10; B62B 1/12; G09F 13/22; B62B 1/26

(52) U.S. Cl. CPC G09F 7/18; G09F 13/22; B62B 1/268; B62B 1/12; B62B 1/10; G09F 2007/1856; G09F 2013/222

(57) ABSTRACT

A manufactured dolly, having wheels, axle and handle, is convertible to an electronic sign board dolly. Included are three support legs cut at a severance point, and a padded cross-tie member housing four pivot and securing brackets with an elongated pivot pin upon which a sign board support channel first end turns. Releasing one of the securing brackets enables the dolly to move to horizontal, held there by an elongated hitch pin; its withdrawal causes it to assume its original position. The dolly includes an angled foot plate that moves under a lower rail so the padded cross-tie member and a balcony handrail may adjoin temporarily, securing the electronic sign board for display. Other functions may include transporting, and operating within both a solar powered, sign board display shack, and electronic sign display center, located anywhere.

### CROSS-REFERENCE TO RELATED APPLICATIONS

This application claims priority to Canadian patent application No. 2,847,136 filed on Mar. 24, 2014, the disclosure of which is incorporated in its entirety by reference herein.

### TECHNICAL FIELD

The present invention relates to mobile advertising equipment and related devices, and more particularly, to LED technology electronic signs; their access and displays on apartment building balconies, their, and other places that desire more effective advertising.

### BACKGROUND

Many apartment buildings still use ineffective advertising methods such as newspaper, internet and stationary ground signs, whereas the present invention may be positioned anywhere, indoor or out, for general use advertising, located on apartment grounds, or balcony.

Most modern balconies have sufficient size, accessibility, and include an electrical outlet, which with time clock, provide power and regulation, for operation of an electronic sign board.

An inexpensive, mobile, electronic sign dolly is ideally suited, not only for apartment building advertising, but also a host of other applications, inside or out, and including the mall, and department stores. A smaller lightweight, two leg version is included, which may be built and placed most anywhere.

This electronic sign board dolly can perform several functions, including transporting its own folded threshold bridge to access apartment building balconies for display; temporarily placing its own solar powered sign board display shack, which not only has lighted signs on three sides, but provides solar/electric power to operate its electronic sign board at any location. When folded up, these electronic sign board dollies are so small and mobile that they can be stored in a garage or most any small space.

It is also desirable to have an electronic sign dolly that may be locked inside a weighted, movable electronic display center at any desired location, for advertising purposes.

### SUMMARY

While a similar electronic sign board conveyance may be made from scratch, even dolly manufacturing companies will find this method, which uses all its parts, but some differently, with none discarded. The present invention addresses and provides an economical and convenient advertising tool and method, not only for apartment buildings, but many other suitable places.

An object of the present invention is to convert a manufactured, standard three leg dolly, to an electronic sign board dolly.

A further object of the present invention is to choose a severance point where all three support legs are evenly cut off.

Another object of the present invention is to affix a padded cross-tie member atop three severed support legs.

It is an object of the present invention to provide an electronic sign board dolly with wheels and axle for mobility.

Another object of the present invention provides an electronic sign board dolly, in which four pivot and securing brackets are affixed to both ends and top of a padded cross-tie member.

An object of the present invention is to provide an electronic sign board dolly, in which pivot and securing brackets securely hold an elongated pivot pin.

A further object of the present invention is to provide an elongated pivot pin upon which a sign board support channel first end turns.

It is an object of the present invention to provide an electronic sign board dolly wherein a pivot and securing brackets provides hitch means for insertion of an elongated hitch pin.

Another object of the present invention is to provide an electronic sign board dolly in which both the upper severed left and upper severed right leg have pivot means provided therein.

A further object of the present invention is to provide an electronic sign board dolly in which an aligned support channel hitch bracket is attached to an underside of a support channel first end.

It is also an object of the present invention to provide an electronic sign board dolly, having an electronic sign board support channel, with first and second ends.

A further object of the present invention is to provide an electronic sign board dolly having a support channel first end with hitch means and pivot means provided therein.

Another object of the present invention is to provide an electronic sign board dolly in which its support channel is fixed in a horizontal position with an elongated hitch pin.

It is also an object of the present invention is to provide an electronic sign board dolly, in a substantially vertical position, in which a second end of a support channel is affixed with a securing pin for desired operational function.

Another object of the present invention is to provide an electronic sign board dolly vertically positioned, wherein withdrawal of an elongated hitch pin causes a support channel second end to drop to an essentially vertical position.

A further object of the present invention is to provide an electronic sign board dolly having a maneuvering handle to facilitate movement as desired.

Another object of the present invention is to provide an electronic sign board dolly having a lower perpendicularly angled footplate to move and protrude under a balcony lower horizontal handrail member.

It is also an object of the present invention to provide an electronic sign board dolly in which a padded cross-tie support member is temporarily secured to a balcony handrail.

A further aspect of the present invention is to provide an electronic sign board dolly which may temporarily transport and place an outdoor solar powered, sign board display shack.

Another object of the present invention is to provide an electronic sign board dolly wherein, in a substantially vertical position, its electronic sign board may normally function and display in a horizontal position within or above a solar sign board display shack.

Advantages of the present invention include; the solar panels and batteries provide power to operate the electronic sign board, positioned on the electronic sign board dolly at any desired location; they may also provide lighting for other signs on the sign board display shack;

A further object of the present invention provides an electronic sign board dolly design which may be utilized and/or adapted to accommodate any type of sign at any desired location.

It is also an object of the present invention to provide an electronic sign board which may function while enclosed and locked inside a weighted, movable, electronic sign display center.

According to one embodiment, a dolly for transporting and displaying signs is provided. The dolly comprises a first frame, a wheel, a bracket, a second frame, and a sign board. The first frame has a rearward end and a forward end, the rearward end having a foot portion for contacting an underlying surface when the first frame is in a generally vertical position. The wheel is attached to the frame at the rearward end of the first frame. The bracket is attached to the frame at the forward end, the bracket defining a pivot axis. The second frame is pivotally connected to the bracket at the pivot axis such that the second frame is pivotable relative to the first frame between an aligned position in which the second frame is generally aligned with the first frame and a transverse position in which the second frame is generally transverse to the first frame. The sign board is mounted to the second frame. Pivoting of the second frame about the pivot axis when the first frame is in the generally vertical position moves the sign board between a generally vertical position and a generally horizontal position.

According to another embodiment, a dolly for transporting and displaying signs includes a first frame, a second frame, and an electronic sign board. The first frame has a rearward end and a forward end, the rearward end connected to a wheel, the forward end defining a pivot axis. The second frame has a forward end, a rearward end, and a length therebetween. The second frame is pivotally connected to the first frame about the pivot axis, the second frame being pivotable between (i) a parallel position in which the second frame is parallel with the first frame and (ii) a transverse position in which the second frame is transverse to the first frame. The electronic sign board is mounted to the second frame and has a length extending along the length of the second frame. Pivoting of the second frame between the parallel position and the transverse position when the first frame is generally vertical moves the sign board between a generally vertical position to a generally horizontal position to display the sign.

### BRIEF DESCRIPTION OF THE DRAWINGS

FIG. 1 is a left side view of an electronic sign board dolly according to one embodiment showing an electronic sign board support frame in a lowered transport position;

FIG. 2 is a left side view of an electronic sign board dolly showing it transporting a balcony threshold bridge and pivotally attached bridge ramps;

FIG. 3 is a left side view of an electronic sign board dolly showing it transporting a sign board display shack;

FIG. 4 is a rear end view of an electronic sign board dolly with an electronic sign board installed for display in a raised position;

FIG. 5 is a right side view of an electronic sign board dolly with a raised support channel;

FIG. 6 is a top view of a threshold bridge with attached inclined ramps, in an extended position;

FIG. 7 is a rear view of an electronic sign board dolly sign board solar powered display shack;

FIG. 8 is a right side view of a solar powered sign board display shack, with an electronic sign board dolly in a display position, capable of function on solar or standard 110v power;

FIG. 9 is a top view of the upper severed components of a standard manufactured three leg dolly, cut evenly off at a severance point;

FIG. 10 is an enlarged side view detail of an electronic sign board dolly showing both elongated pivot and hitch pins, and a left side, end securing bracket;

FIG. 11 is an enlarged rear end view of an electronic sign board dolly showing four pivot and securing brackets, affixed to and upon a padded cross-tie member, with elongated pivot and hitch pins, and a view of the center support leg; and

FIG. 12 is a side view of an electronic sign board dolly locked inside a movable, weighted, electronic sign display center.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

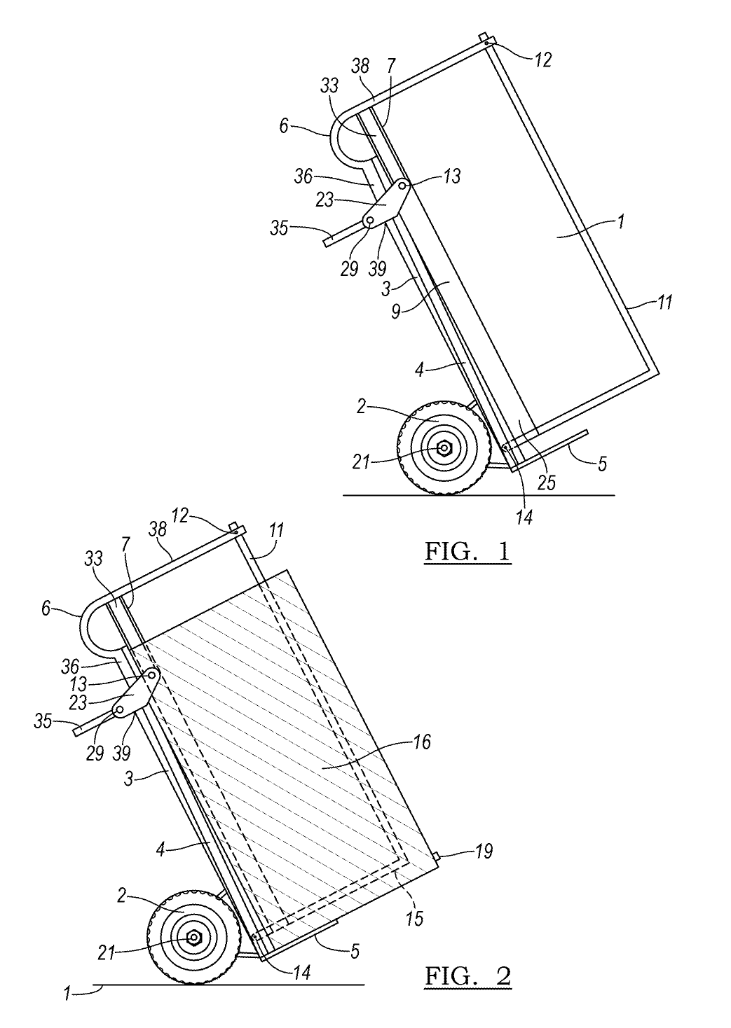

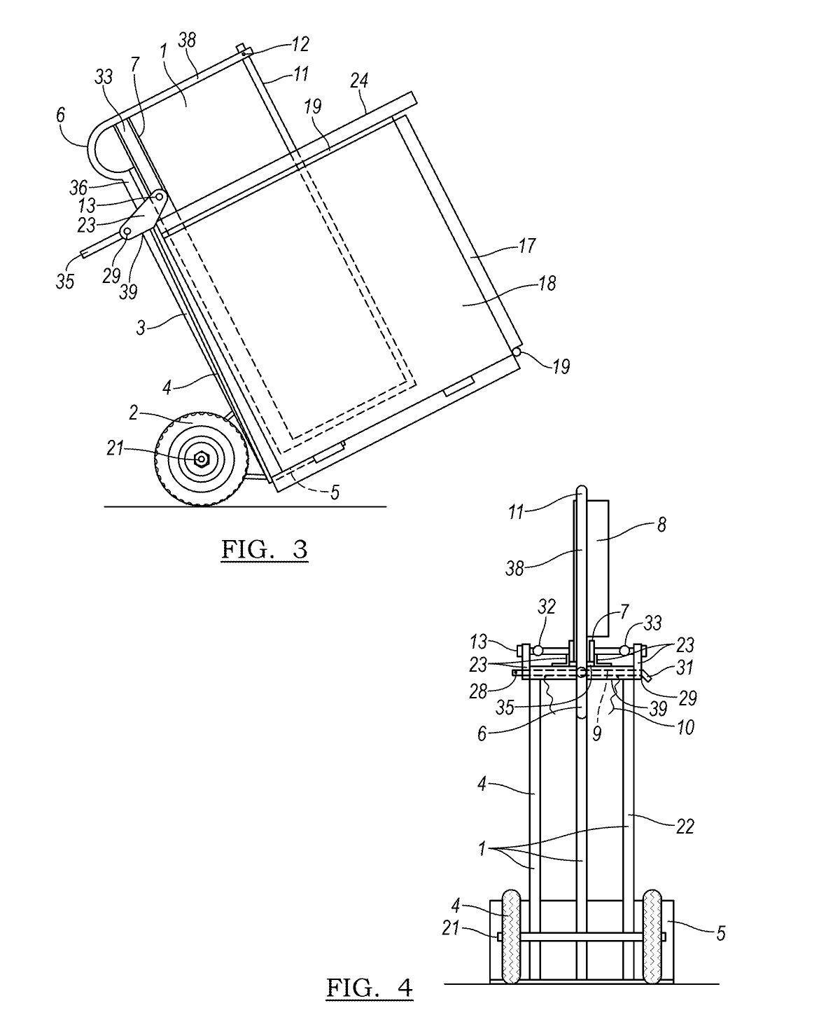

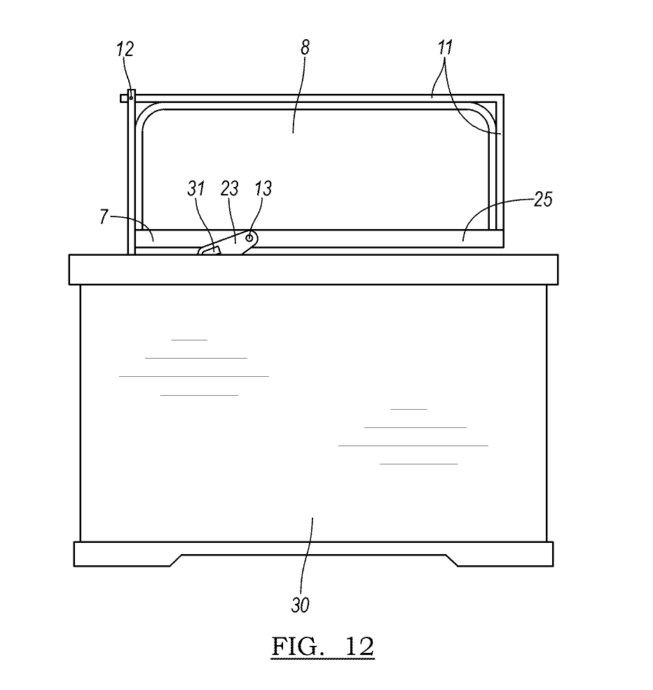

Referring to FIGS. 1, 2, 3 and 6, wherein the present invention shows some tasks of an electronic sign board dolly (1) i.e. transporting folded balcony threshold bridge (15) with its two inclined ramps (16), hinges (19), and moving a solar powered sign board display shack (18); after being converted from a suitable, three leg manufactured dolly, by evenly cutting off its three support legs at severance point (39), wheels (2) and axle (21) are retained for mobility; a padded cross-tie member (9) with stretch cords (10) pivot and securing brackets (23) holding elongated pivot pin (13), are affixed atop all three, lower severed left leg (4), lower severed right leg (22), and lower severed center leg (3), in this position hitch means (29) is shown, support leg (35), and upper support frame (11) with corner fastener (12), which may be removed, when desired. Other uses include a weighted, portable electronic sign display center (30), located most anywhere. (See FIG. 12)

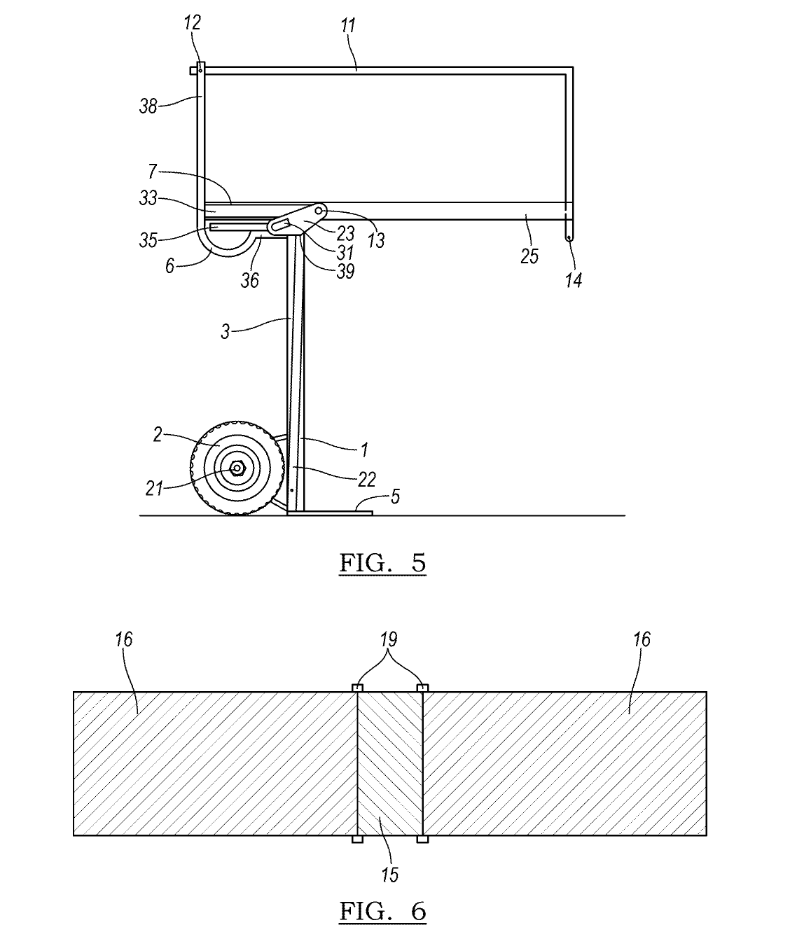

Referring now to FIGS. 4 and 5 (without sign board (18)) in its vertical position, withdraw of securing pin from bracket (14) to release second end support channel (25) allowing electronic sign board (8) to move on elongated pivot pin (13) with support channel first end (7), secured horizontally by elongated hitch pin (31), through support channel hitch bracket (34) and securing pin (28) at hitch means (29). Handle (6), and all the upper components, directly or indirectly pivot on elongated pivot pin (13), to put the electronic sign board in its horizontal display position.

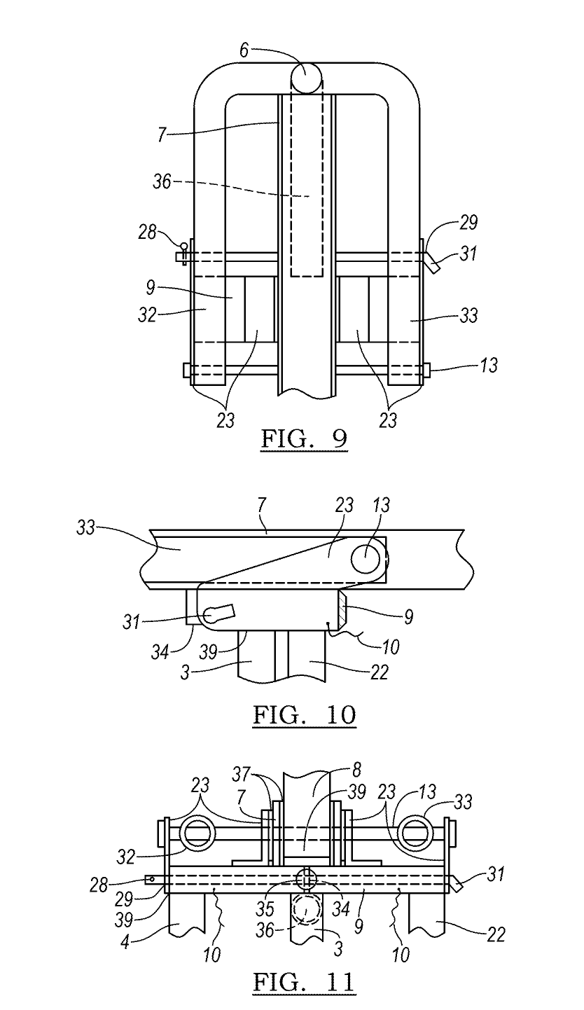

Referring now to FIGS. 9, 10 and 11, are enlarged to show the function more clearly, i.e. lower left support leg (4)—is upper severed left leg (32), (right—lower (22) is upper (33), lower center leg (3) is upper (36), shown in (FIG. 5) with maneuvering handle (6) enabling angled footplate (5) to move outward under a lower horizontal handrail member until generally parallel contact between its padded cross-tie member (9) and a balcony handrail, to temporarily be secured with stretch cords (10) placing the electronic sign generally perpendicular thereto, for display. two pivot and securing brackets (23) are padded cross-tie member end pieces, and two others are end support angle pieces;

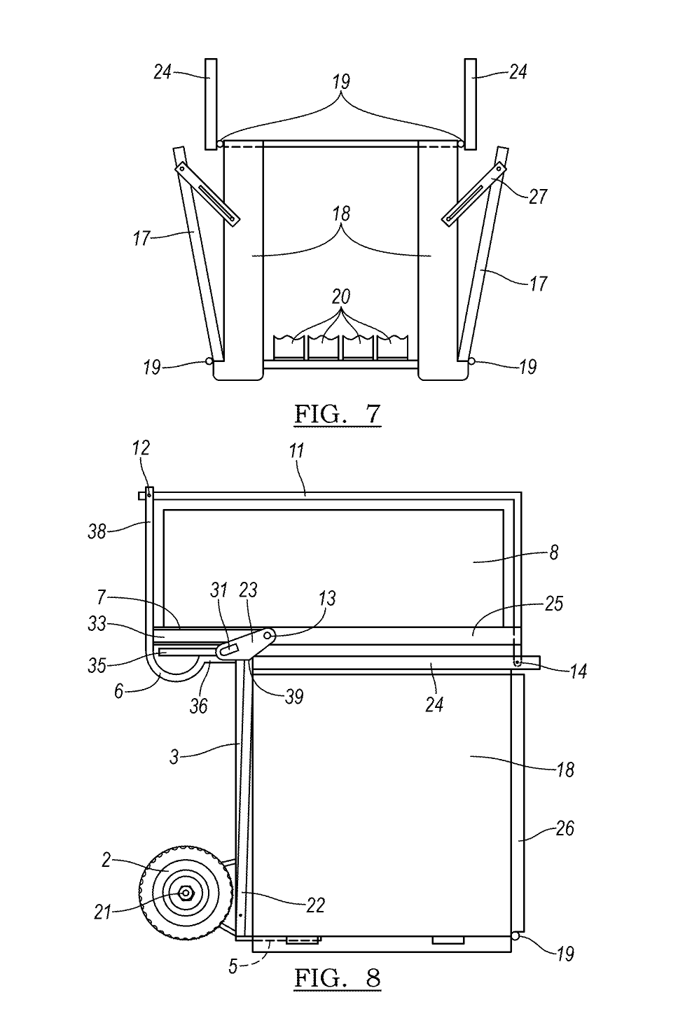

Referring now to FIGS. 7 and 8 in which the electronic sign board dolly (1) may transport and temporarily locate a sign board display shack (18) having solar side panels (17), top solar panels (24) and rear solar (26) with angle adjustors (27), batteries, (20) and accessories, as power source, enabling operation of the electronic side board (8) wherever desired, and including provision of lighting for other signs, or other purposes. Alternately, conventional power may be used to operate any lighting, signs, and time clocks, when convenient.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A dolly for transporting and displaying signs, the dolly comprising:
a first frame having a rearward end and a forward end, the rearward end having a foot portion for contacting an underlying surface when the first frame is in a generally vertical position;
a wheel attached to the frame at the rearward end;
a bracket attached to the frame at the forward end, the bracket defining a pivot axis;
a second frame pivotally connected to the bracket at the pivot axis such that the second frame is pivotable relative to the first frame between an aligned position in which the second frame is generally aligned with the first frame and a transverse position in which the second frame is generally transverse to the first frame; and
a sign board mounted to the second frame;
wherein pivoting of the second frame about the pivot axis when the first frame is in the generally vertical position moves the sign board between a generally vertical position and a generally horizontal position.

2. The dolly of claim 1, wherein a hitch pin connectable to the bracket to secure the second frame and mounted sign board in the transverse position.

3. The dolly of claim 2, wherein the second frame is biased to the aligned position such that removal of the hitch pin when the second frame is in the transverse position causes the second frame to move to the aligned position.

4. The dolly of claim 1, wherein the second frame includes a rearward end and a forward end, the rearward end of the second frame aligning with the rearward end of the first frame when the second frame is in the aligned position.

5. The dolly of claim 4, further comprising a handle at the forward end of the second frame.

6. The dolly of claim 4, wherein the second frame includes a securing bracket at the rearward end of the second frame to secure the second frame to the first frame at the respective rearward ends.

7. The dolly of claim 6, wherein the securing bracket secures the second frame to the first frame at a location forward of the foot portion.

8. The dolly of claim 1, wherein the sign board is a first sign board, the dolly further comprising a second sign board mounted to the first frame, wherein the first sign board is pivotable relative to the second sign board about the pivot axis.

9. The dolly of claim 1, wherein the second frame includes a pair of spaced apart frame rails, and wherein the first frame is connected to the second frame at location between the pair of frame rails.

10. The dolly of claim 1, wherein the first frame includes a pair of spaced apart frame rails, each frame rail connected to a respective sign panel, and wherein the second frame is connected to the first frame at a location between the pair of frame rails such that the sign board is between the respective sign panels when the second frame is in the aligned position.

11. The dolly of claim 1, wherein the sign board is an electronic sign board, the dolly further comprising solar panels mounted to the first frame and electrically coupled to the electronic sign board.

12. A dolly for transporting and displaying signs, the dolly comprising:
a first frame having a rearward end and a forward end, the rearward end connected to a wheel, the forward end defining a pivot axis;
a second frame having a forward end, a rearward end, and a length therebetween, the second frame pivotally connected to the first frame about the pivot axis, the second frame pivotable between (i) a parallel position in which the second frame is parallel with the first frame and (ii) a transverse position in which the second frame is transverse to the first frame;
an electronic sign board mounted to the second frame, the electronic sign board having a length extending along the length of the second frame;
wherein pivoting of the second frame between the parallel position and the transverse position when the first frame is generally vertical moves the sign board between a generally vertical position to a generally horizontal position to display the sign.

13. The dolly of claim 12, wherein a hitch pin secures the second frame in the transverse position.

14. The dolly of claim 13, wherein the second frame is biased to the parallel position such that removal of the hitch pin when the second frame is in the transverse position causes the second frame to move to the parallel position.

15. The dolly of claim 12, wherein the rearward end of the second frame aligns with the rearward end of the first frame when the second frame is in the parallel position.

16. The dolly of claim 15, further comprising a handle at the forward end of the second frame to provide a region for a user to grasp and pivot the second frame relative to the first frame.

17. The dolly of claim 12, wherein the second frame includes a pair of spaced apart frame rails, and wherein the first frame is connected to the second frame at location between the pair of frame rails.

18. The dolly of claim 12, wherein the first frame includes a pair of spaced apart frame rails, each frame rail connected to a respective sign panel, and wherein the second frame is connected to the first frame at a location between the pair of frame rails such that the sign board is between the respective sign panels when the second frame is in the parallel position.
